(19) United States
(12) Patent Application Publication
(10) Pub. No.: US 2009/0027775 A1
(43) Pub. Date: Jan. 29, 2009

(54) Multiple layer reflective tag

(76) Inventors: Robert B. Nilsen, Mystic, CT (US); Gus Bernard, Ocean Ridge, FL (US); Garrett L. Nilsen, Mystic, CT (US)

Correspondence Address: William M. Hobby, III, #375, 157 E. New England Avenue, Winter Park, FL, 32789, US

(21) Appl. No.: 11/878,812

(22) Filed: Jul. 26, 2007

(51) Int. Cl. G02B 5/12

(52) U.S. Cl. 359/515; 359/530

(57) ABSTRACT

A reflective tag apparatus has a top layer having micro apertures therein and having a surface message therein and a second layer having a sub surface message thereon mounted over a reflective layer. The reflective layer may be retroreflective using an array of corner cubes and may be a structure that is diffractive or resonates iridescent colors and may contain coatings, dyes and pigments to provide light control.

### BACKGROUND OF THE INVENTION

A reflective tag apparatus has a top layer having micro apertures or windows therethrough and may be formed as a pattern that is digitally printed onto a light transparent film or sheet. A surface message may also be printed thereon and a second layer may have a sub surface message thereon mounted over a reflective layer. The reflective layer may be retroreflective using an array of corner cubes and may be a structure that is diffractive or resonates iridescent colors and may contain coatings, dyes and pigments to provide light control.

Traditional reflective tags are made from reflective and/or retroreflective materials which have a smooth glossy front surface. The front surface often has a coating for permitting selective transmission of various wavelengths of light. The front surface of the reflective tag is specular to achieve optimum non scattering of light optical performance. The specular nature of the front surface of the reflective tag is not desirable in situations where the specular reflection may cause a false signal to sensing equipment or sensing instruments. In some cases the color or plain appearance of the front surface of the reflective tag may also be undesirable. Also traditional tags may have an alpha numeric message or a coded message such as a bar code on the top surface of the reflective tag. In some security situations it is desirable to have the message hidden or disguised. Reflective tags are typically used for automated guidance systems, entry way security systems, vehicle and personal night time safety, currency and other identification systems, as well as communication between transmitting and receiving bases using light transmission in vacuum environments such a space, but also in atmospheric conditions such as found on moons and planets.

Prior art patents for multiple layer reflective articles can be seen in the Kuykendall et al. U.S. Pat. No. 6,656,566 for a retroreflective luminescent article and sheeting material that contains a retroreflective layer and a layer of luminescent material on the bottom or lower surface of the retroreflective layer. The sheeting material is such that it can be formed into signage or decorative articles that are visible under different lighting conditions. A portion of the retroreflective layer is visible through the luminescent layer through one of the openings in the luminescent layer which are in the form of slits, perforations, alphanumeric or other patterns. An image can be placed on the luminescent layer. This patent discusses prior art types of a retroreflective material which can be microspheres or a material, such as glass, that have a specular reflecting layer coated on one surface to reflect the incident light or it can be made up of cube corner elements.

In the DeMott et al. U.S. Pat. No. 6,764,744, a diffractive and retroreflective textile fabric has a composite fabric structure which includes a textile fabric layer having a visual surface and a rear surface. A layer of diffractive or retroreflective material is secured beneath the textile fabric layer either directly or beneath a layer of substantially transparent material. The textile fabric layer is of an open or semi-transparent construction so that light can pass through it to reach the layer of diffractive or retroreflective material and be reflected back through the layer of textile fabric.

Other retroreflective patents include the Smith et al. U.S. Pat. No. 5,450,235 for a flexible cube-corner retroreflective sheeting which has a light transmissible polymeric material connected to a plurality of corner cube elements. The Benson U.S. Pat. No. 5,122,902 is a retroreflective article having light transmissive surfaces. The retroreflective elements are corner cube elements arranged on articles to define separation surfaces between the elements. In the Spencer et al. U.S. Pat. No. 5,315,491, a reflecting and luminous layered material combines a light reflective component and a luminescent component. In the Spencer et al. U.S. Pat. No. 5,300,783, a flexible layered reflective and luminous material has a light reflective component and a luminescent component. In the Spencer U.S. Pat. No. 5,243,457, a flexible visibility enhancing material has a light reflective component and a luminescent component. U.S. Pat. No. 5,138,488 to Szczech shows a retroflective material with improved angularity. U.S. Pat. No. 7,236,296 teaches a mutilayer wavelength control for controlling color fluctuations in solar filming.

The present invention is for a multiple layer reflective tag in which both the first and second layer can have intelligence bearing material on the surface while a third and optional fourth layer are made of wavelength control materials for passing predetermined wavelengths or light therethrough. The bottom layer is a reflective surface, such as a retroreflective array of corner cubes.

### SUMMARY OF THE INVENTION

An object of the present invention is to provide a reflective tag that may be viewed at short and long distances, does not have specular reflection that will cause false signals, has a color or pattern of color which is desired and which may also contain a hidden message or signaling means. A further object of the present invention is to provide a reflective tag that is capable of reflecting a wide band of light wavelengths or only specific wavelengths of light.

The reflective tag may have micro apertures which are of any shape. The most preferable shapes are circular micro holes or rectangular holes, though the apertures may also be in the shape of rectangles, squares, triangles or free form shapes of any size area. The micro apertures may be put into any type of material including polymers, textiles, fabrics, leather, metal, glass and ceramic materials, wood and wood products, paper and paperboard, or any combination of materials.

In one embodiment the reflective tag consist of a plain or patterned top layer containing micro-apertures, a message bearing 2^{nd} layer, a wavelength control 3^{RD} layer and a retroreflective 4^{th} layer.

The reflective tag may consist of multiple sections, each section consisting of a plain or patterned top layer containing micro apertures, a message bearing 2^{nd} layer, a wavelength control 3^{rd} layer and a retroreflective 4^{th} layer. Each section is designed to reflect at different wavelengths of light.

In another embodiment the reflective tag may have a plain or patterned top layer containing micro apertures, a message bearing 2^{nd} layer, a first wavelength control 3^{rd} layer, a second wavelength control 4^{th} layer and a retroreflective 5^{th} layer.

In another embodiment the reflective tag consists of multiple sections of reflective tag. Each section of the reflective tag has a plain or patterned top layer containing micro apertures, a message bearing 2^{nd} layer, a first wavelength control 3^{rd} layer, a second wavelength control 4^{th} layer and a retroreflective 5^{th} layer. Each section is designed to reflect at different wavelengths of light.

In each embodiment above the plain or patterned top layer containing micro holes may be continuous or segmented across each section of the tag.

In each embodiment the retroreflective layer may be printed with a distinct message for identification, usually as the result of interrogation from a base station, such as in a communication station, or the retroreflectors may be MEMS with the ability to send a programmed message to the transmitting station, identifying location, local conditions or other pertinent information. This message may be sent by an on-off code, such as morse code, or may be a continuous identifying pattern, which can be modulated for covert operations.

In each embodiment above the back of the retroreflective layer may be coated and/or bonded to a substrate. The substrate may be the surface of another object or may be an attachment mechanism designed to attach to another object.

In each embodiment above the top plain or patterned micro aperture layer does not need to be attached to the 2^{nd} layer. The top plain or patterned micro aperture layer may be made from a polymer, a fabric consisting of textiles such as cotton and/or polymers and or metal and/or glass and or ceramic, a metal, a glass or a ceramic, wood, paper, paperboard or the like, masonite or similar materials, ceramic tiles and many commercial film products which have valuable environmental properties such as Tyvek sold by Dupont.

Each embodiment above or the embodiment which is not attached to the top surface may be enclosed within a protective material.

Any tag not attached to the top surface may also be placed beneath a protective masking layer as protection during shipment, with the present invention acting as a tracking or shipment device.

A multiple layer reflective tag has a first layer having a plurality of micro-apertures therein for the transmission of light therethrough while reflecting or absorbing light therefrom. The first layer may have a readable image or indicia thereon. A second layer below the first layer is made of a transparent material and has indicia or an image or coded information thereon. A third layer below the second layer may be a wavelength control material for passing predetermined wavelengths of light therethrough and reflecting other wavelengths of light therefrom. The fourth or bottom layer is a reflective or retroreflective surface for reflecting light impinging thereupon. An optional fifth layer can be placed between the third and fourth layer which also controls a different wavelength from the third layer. The reflective tag reflects predetermined wavelengths along with predetermined information embedded in the reflective tag. The first layer can have surface indicia thereon and the bottom layer can be an array of corner cubes each having a predetermined pitch. The first layer has micro-apertures of a predetermined size. Indicia on the second layer can include a bar code or other coded information or any intelligence bearing surface. The first layer can be a polymer fabric layer or a cloth fabric layer or any of a number of materials, as desired. The retroreflectors may be a micro-electro-mechanical system or MEMS with the ability to send programmed messages to a transmitting starter.

### BRIEF DESCRIPTION OF THE DRAWINGS

Other objects, features, and advantages of the present invention will be apparent from the written description and the drawings in which:

FIG. 1 is a cross-section of a multiple layer reflective tag in accordance with the present invention;

FIG. 2 is a modified cross-section of the reflective tag of FIG. 1;

FIG. 3 is another modified cross-section of the reflective tag of FIG. 1;

FIG. 4 is yet another modified cross-section of the reflective tag of FIG. 1 having a separated top layer;

FIG. 5 is a modified cross-section of the reflective tag of FIG. 4;

FIG. 6 is a cross-section of the reflective tag of FIG. 5 having layers encapsulated;

FIG. 7 is a cross-section of an assembly with different areas having different performance properties; and

FIG. 8 is a cross-section showing the encapsulation of the present multiple layer reflective tag.

### DETAILED DESCRIPTION OF THE PREFERRED EMBODIMENT

The foregoing and other objects, features and advantages of the invention will be apparent from the following more particular description of preferred embodiments of the invention, as illustrated in the accompanying drawings in which like reference characters refer to the same parts throughout the different views.

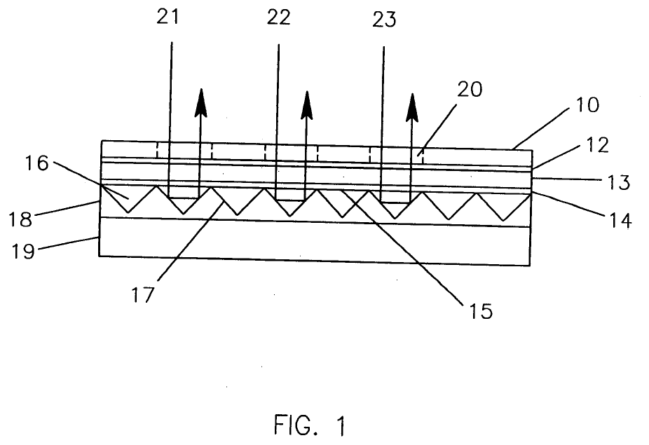

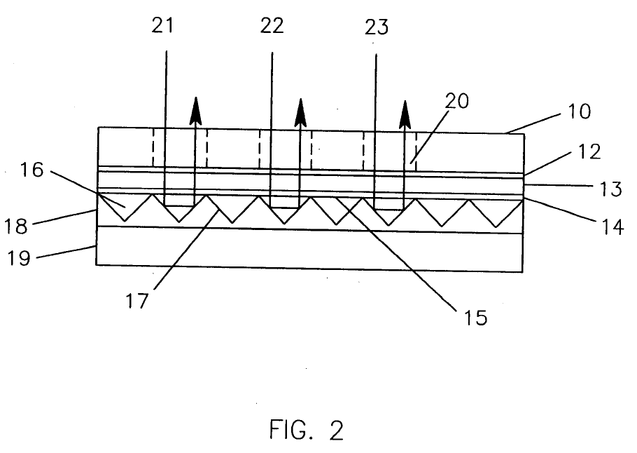

In the drawings, FIGS. 1 through 6 show an assembly of the components that make up a preferred embodiment of the present invention. The top layer 1 may be made of any material including low and high modulus of elasticity polymers, fabrics, textiles, leather, metal, glass and/or ceramic, wood, paper, paperboard or the like, masonite or similar materials, ceramic tiles and many commercial film products which have valuable environmental properties such as Tyvek, sold by Dupont, or any combination of the above materials. The micro apertures 20 in FIG. 2 are formed completely through top layer 10. The micro-apertures may be printed onto the front or rear surface of top layer 10 to form windows or light apertures through top layer 10. The micro-apertures 20 may be of any size and preferably are of a size which is larger than the pitch of the reflective structures 16. Corner cubes are shown as the reflective structures 16 in each figure. However the reflective structure 16 may also be a diffractive structure or coating, a resonate structure or coating, a reflective structure or coating, or any combination of these, structures together and/or with corner cube structures. For maximum retroreflected light performance while at the same time hiding the layers below top layer 10, the corner cubes pitch is 0.0005″ to 0.010″ and more preferably 0.001″ to 0.004″ while the apertures 20 are one to three times the width of the pitch of the corner cubes. Ideally the apertures are less than 0.012″ so that they are not visible to the unaided eye at viewing distances of two feet or more. The average unaided eye can resolve 0.008″ to 0.010″ at normal reading distance of about 12″. The apertures 20 may be of any shape including rectangles, squares, triangles or free form shapes of any size area. Rectangular aperture shapes 20 of 0.006″ wide and long may be made as parallel rows in top surface 10. The rows are spaced apart by 0.012″ leaving two-thirds of the area of top surface 10 visible. For this size aperture 20 a reflective structure 16, corner cube for example, will have a pitch of approximately 0.002″ to 0.004″. The first surface of top surface 10 may have a pattern applied to it. The apertures 20 may be a regular or random array of circular holes which are 0.008″ to 0.012″ in diameter and are spaced apart by, for example, 0.020″ to 0.030″. For this size aperture 20 a reflective structure 16, corner cube for example, will have a pitch of approximately 0.002″ to 0.006″.

In FIGS. 1 and 2, a layer 12 may be a selective wavelength coating. These coatings are designed to block visible light and transmit IR light beyond the transmission cut off. These coatings are applied to a substrate 13 and may have a glossy or matte top surface finish. The selective wavelength dyes which are in the coatings may also be extruded or molded into a polymer film and the coating on substrate 13 can be replaced by the substrate 13 which contains the dyes. The extruded film containing dyes is more durable than a coating. Another layer, not shown, may be applied to the coating top surface to redirect the light that is being reflected from reflective structure 16. This layer is located between top layer 10 and coating layer 12.

Another layer 14 is a second coating which may be applied to the bottom surface of substrate 13 or to the top surface of reflective structure 16. An additional layer 15 may be applied to the top surface of reflective structure 16 and the second coating or layer 14 then applied to the top surface of this added layer 15. This second coating is designed to have transmission properties depending on the coating that is applied to layer 12.

The transmission performance resulting from the two superimposed coating layers will create a notch transmission window. Many types of coatings containing dyes or multiple layers of metals and dielectrics or multiple layers of dielectrics may be combined together to create transmission notches in any part of the spectrum. In some cases a single coating may be used to create a transmission or reflection notch. An interference coating 17 can be applied to open faced reflective structures 16, such as open faced corner cubes, to allow only UV light of 290 nm to 390 nm to reflect while all other light is passed into or through the reflective structure 16. The top layer 10 may be located directly above the top surface of the structure 16. In this case, coatings and layers 12, 13, 14 and 15 are not required.

In the example of FIGS. 1 and 2, coating 12 and/or substrate 13 and/or coating 14 and/or another substrate below coating 14 and/or the reflective structure 16 and/or a reflective coating applied to reflective structure 16 may have a message applied thereon. The message may be an alpha numeric or coded, such as a bar code, or a printed message. More than one message may be contained within the invention including the pattern applied to the top surface of layer 10 which contains the micro-apertures.

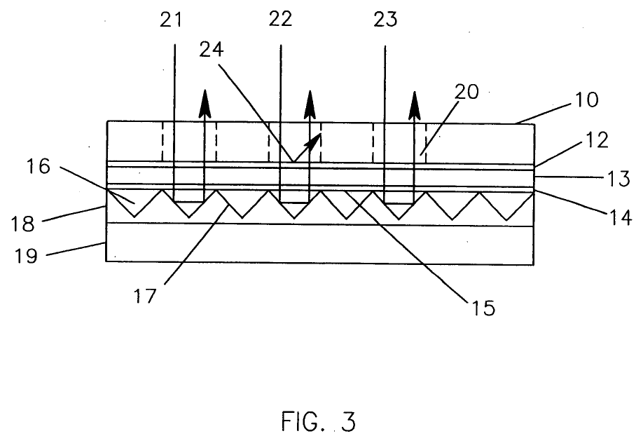

FIG. 3 is another embodiment of the invention showing the top layer 10 having a thickness and aperture 20 size designed to capture or act as a light baffle to block rays that are incident on the embodiment from wide angles of incidence, as shown by light ray 24. The same aperture will also act to control the direction, intensity and distribution of light reflected from structure 16.

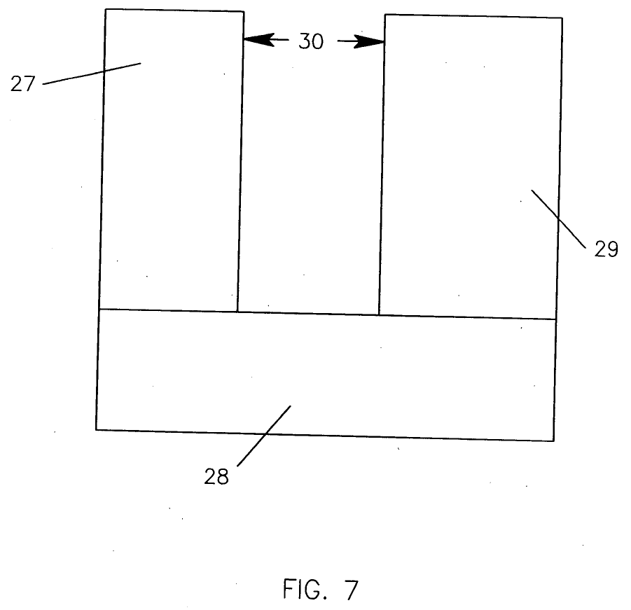

In FIG. 3, light rays 21, 22 and 23 serve to show that light from different section of the embodiment may have different performance properties depending on the coatings used and the size of the structure 6 and/or apertures 20. FIG. 7 is an example of an assembly of an embodiment where three different areas 27, 28 and 29 each may have different performance properties. For example, area 27 may be optimized to function in one wavelength region, area 28 may be optimized to function in a second wavelength region and area 29 may be optimized to function in a third wavelength region. One or many wavelength regions may be incorporated into an assembly. Each area may be of any shape or size.

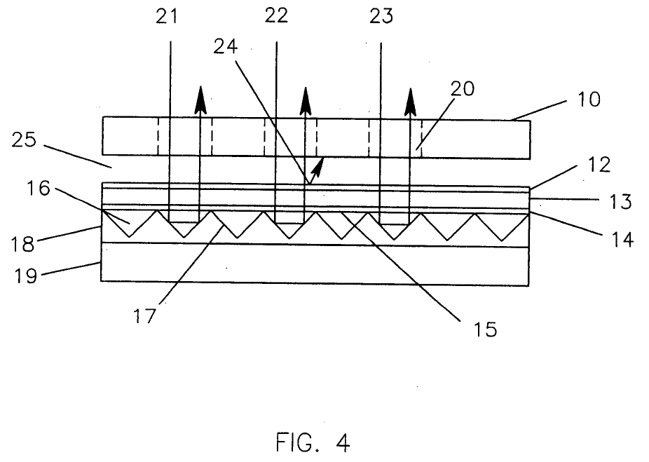

In FIG. 4, an example of an embodiment is shown where the top layer 10 is separate from the other layers of the embodiment. Top layer 10 does not need to be attached to the remaining layers. The micro-apertures or windows 20 are designed in shape and size to work in any position with respect to the reflective structure 16 which is reflecting the light. The top surface of layer 10 or layer 12 may contain a micro-texture that scatters visible light and not IR light and alternatively, the micro texture may be a motheye structure that does not reflect visible or IR light. The apertures 20 may be formed by printing on the top or bottom of layer 10. Printing on the bottom is preferred to protect the printed layer.

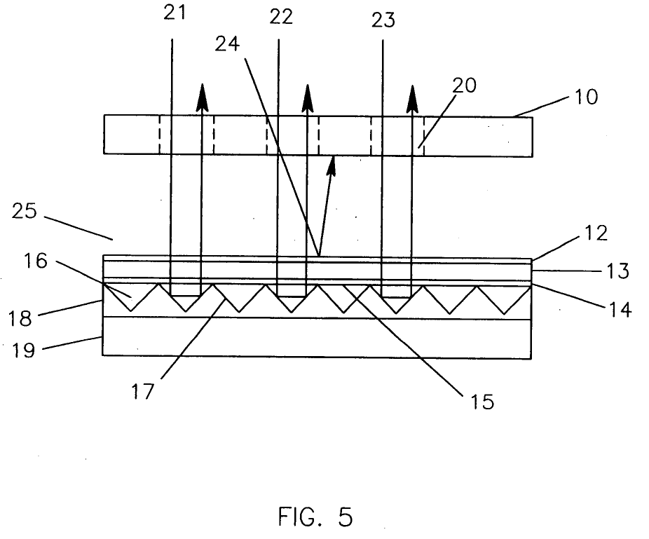

FIGS. 4 and 5 show how a light ray 24 will be blocked as a result of the spacing 25, between top layer 10 containing micro apertures 20, and the rest of the layers of the embodiment.

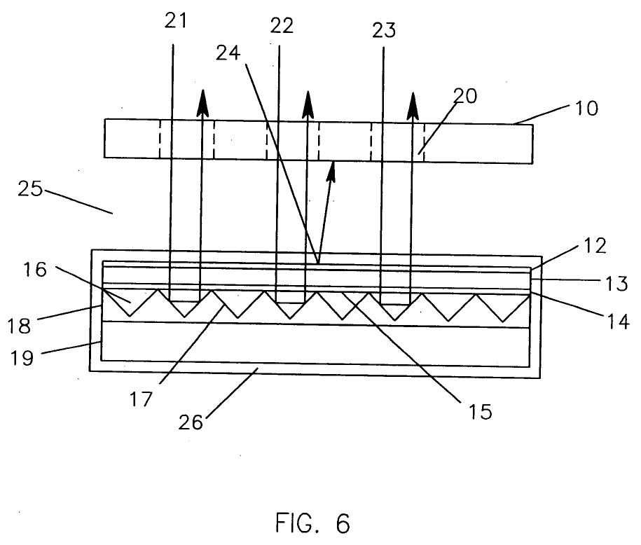

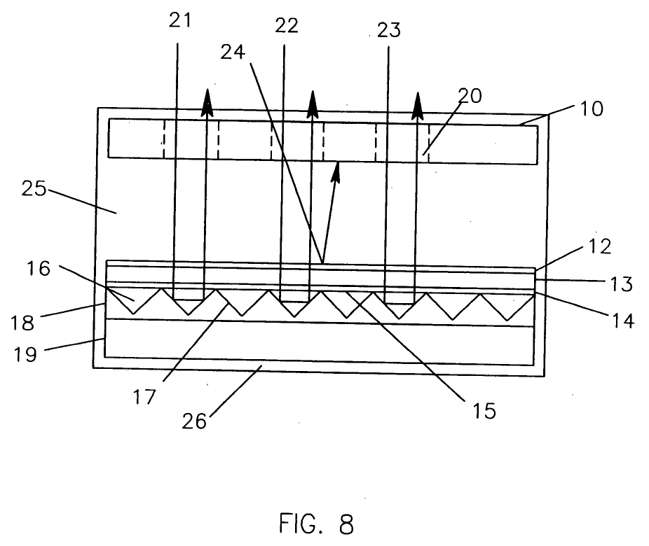

FIG. 6 shows that the layers of this embodiment may be encapsulated within a transparent material 26 while FIG. 8 shows the encapsulation of the entire multiple layer reflective tag. The encapsulating material 26 may have wavelength selective transmission properties. The encapsulating material 26 may be designed to add durability to the embodiment. For example if top layer 10 is a fabric and the remainder of the embodiment is sewn into a pocket in a garment, the encapsulated material 26 will protect the remainder of the embodiment from the chemicals used in the wash solution.

The reflective tag may or may not contain layers 18 and 19 as desired. Layer 18 may be a coating designed to protect the reflective coating 17 on the back of solid corner cube structures. Layer 18 may also be an adhesiveable layer 19 may be a backing material.

Top layer 10 may also have a reinforcing backing material applied to it. If top layer 10 is a thin fabric, a reinforcing layer like PET may be applied to the back of the material. The micro apertures 20 are then formed through the fabric and the PET backing material.

Top layer 10 may also have an adhesive applied to back surface. If top layer 10 is a label material such as PET, PVC, or paper, the adhesive may be used to bond top layer 10 to the rest of the embodiment. The micro apertures 20 are then formed through the label material and the adhesive. In the case of printed apertures on the back of layer 10, an optical grade adhesive may be used across the entire back surface of layer 10 and in the printed area.

Referring to all of the drawings, a reflective tag of many layers has a first layer 10 having a regular or irregular array of micro holes 20, preferably 0.005 to 0.020 inches in diameter, spaced on center from 0.005 to 0.020 inches, which micro-holes 20 can be circular, rectangular or of any other shape. The first layer 10 can be made of polymers, textiles, fabrics, leather, metal, glass and ceramic materials, wood and wood products, paper and paperboard, or any combination of materials. A second layer 12 is a selectable coating containing printed messages thereon.

A third layer 14 is a wavelength control layer which is a selective wavelength coating designed to block visible light and transmit IR light beyond a transmission cut off. Another coating or layer 15 may be applied to the coating top surface to redirect the light that is being reflected from the corner cubes.

A fourth layer 16 consisting of an array of corner cubes are sized for maximum retroreflected light performance while at the same time hiding the layers below the top layer, the corner cubes pitch is 0.0005 inch to 0.010 inch and more preferably 0.001 inch to 0.004 inch.

Each layer may reflect at different wavelengths of light or all layers can reflect light at the same wavelength. The second layer 12 may contain a bar code, a code or message which can be visible at alternative wavelengths from the other layers. The fourth layer may be a retroreflection of corner cubes of different pitch as desired. The top layer 10 may be plain or patterned containing micro-holes which are continuous or segmented across the surface of the tag.

The retroreflective layer 16 may be printed with a distinct message for identification, usually as the result of interrogation from a base station, such as in a communication station, or the retroreflectors may be MEMS with the ability to send a programmed message to the transmitting station, identifying location, local conditions or other pertinent information. This message may be sent by an on-off code, such as morse code, or may be a continuous identifying pattern, which can be modulated for covert operations.

The back of the retroreflective layer 16 may be coated and/or may be bonded to a substrate. The substrate may be the surface of another object or may be an attachment mechanism designed to attach to another object.

The top plain or patterned micro-aperture layer 10 does not need to be attached to the 2^{nd} layer. The top plain or patterned micro-aperture layer 10 may be made from a polymer, a fabric consisting of textiles such as cotton and/or polymers and or metal and/or glass and or ceramic, a metal, a glass or a ceramic, wood, paper, paperboard or the like, masonite or similar materials, ceramic tiles and many commercial film products which have valuable environmental properties such as Tyvek sold by Dupont. The tag, when not attached to the top surface, may be enclosed within a protective material. Where the tag is not attached to the top surface, it may be placed beneath a protective masking layer, which is applied to many consumer products as protection during shipment, with the present invention acting as a tracking or shipment device.

A more specific embodiment of the reflective tag having many layers includes a first layer 10 having a regular or irregular array of micro-holes, preferably 0.005 to 0.020 inches in diameter, spaced on center from 0.005 to 0.020 inches. Each micro-hole 16 may be circular, rectangular or of any other shape. The material of the first layer 10 may be a polymer, textile, fabric, leather, metal, glass or ceramic or wood and wood products, paper and paperboard, or any combination of materials.

The second layer 12 may consist of a selectable wavelength coating containing printed messages while a third layer 14 is a wavelength control layer which may have a selective wavelength coating designed to block particular wavelengths and transmit particular wavelengths beyond a transmission cut off. Another coating layer may be applied to the coating top surface to redirect the light that is being reflected from the corner cubes.

A fourth layer may be a second wavelength control layer having a selective wavelength coating designed to block particular wavelengths and transmit particular wavelengths beyond a transmission cut off. Another coating layer may be applied to the coating top surface to redirect the light that is being reflected from the corner cubes. A fifth layer 16 may be an array of corners cubes sized for maximum retroreflected light performance while at the same time hiding the layers below the top layer. The corner cubes pitch may be 0.0005 inch to 0.010 inch and more preferably 0.001 inch to 0.004 inch.

Each section of the reflective tag may operate at different wavelengths or may reflect different wavelengths of light or may reflect light at the same wavelength. The second layer 12 may contain a bar code, a code or message which can be visible at alternative wavelengths from the other layers of the invention. The fourth layer 16 may be a plurality of corner cubes of different pitch.

The plain or patterned top layer 10 containing micro-holes 20 may be continuous or segmented across the surface of the tag.

While the invention has been particularly shown and described with reference to preferred embodiments thereof, it will be understood by those skilled in the art that various changes in form and details may be made herein without departing from the spirit and scope of the invention as defined by the appended claims.

We claim:

1. A multiple layer reflective tag comprising:
a first layer having a plurality of apertures therein for the transmission of light therethrough while reflecting light therefrom;
a second layer positioned under said first layer and made of a transparent material and having information bearing images or indicia thereon;
a third layer positioned under said second layer and made of a wavelength control material for passing predetermined wavelengths of light therethrough and reflecting other wavelengths of light therefrom; and
a reflective layer positioned under said third layer and having a reflective surface for reflecting light energy impinging thereupon;
whereby a reflective tag reflects predetermined wavelengths along with predetermined information embedded in the reflective tag.

2. The multiple layer reflective tag in accordance with claim 1 in which said reflective layer reflective surface is a retroreflective surface.

3. The multiple layer reflective tag in accordance with claim 2 in which said reflective layer has a retroreflective surface having an array of corner cubes.

4. The multiple layer reflective tag in accordance with claim 3 in which each said corner cube of said reflective layer array of corner cubes has a predetermined pitch of between 0.0005 and 0.160 inches.

5. The multiple layer reflective tag in accordance with claim 3 in which said first layer has information bearing images or indicia thereon.

6. The multiple layer reflective tag in accordance with claim 5 in which each said layer reflects or transmits or absorbs a different wavelength.

7. The multiple layer reflective tag in accordance with claim 5 in which said first layer multiple apertures each have a diameter of between 0.005 and 0.250 inches.

8. The multiple layer reflective tag in accordance with claim 1 in which said second layer information bearing image includes a bar code.

9. The multiple layer reflective tag in accordance with claim 2 in which said second layer information bearing image includes encoded information.

10. The multiple layer reflective tag in accordance with claim 2 in which said reflective tag is enclosed in a transparent cover to thereby protect the reflective tag.

11. The multiple layer reflective tag in accordance with claim 2 in which said first layer is a fabric layer having a plurality of apertures therein, each aperture having a diameter of between 0.005 and 0.250 inches bar code.

12. The multiple layer reflective tag in accordance with claim 9 in which said first layer is a polymer fabric layer.

13. The multiple layer reflective tag in accordance with claim 10 in which said first layer is a textile fabric layer.

14. The multiple layer reflective tag in accordance with claim 4 in which said reflective layer array of corner cubes includes a plurality of corner cubes each having a different pitch between 0.0005 and 0.160 inches.

15. The multiple layer reflective tag in accordance with claim 2 having a fourth layer positioned between said third layer and said reflective layer, said fourth layer being a layer of wavelength control material for reflecting or absorbing predetermined wavelengths of light energy some of which are different from the wavelengths reflected or absorbed by said third layer and transmitting other wavelengths of light therefrom.

16. A multiple layer reflective tag comprising:
a first layer made of a transparent material for the transmission of light therethrough;
a printed second layer applied to the top or bottom surface of the first layer, said printed second layer having a plurality of apertures therein.
a third layer made of a wavelength control material for passing predetermined wavelengths of light therethrough and reflecting or absorbing other wavelengths of light therefrom and having information bearing images or indicia thereon, said third layer being positioned under said first and second layer; and
a reflective layer positioned under said third layer and having a reflective surface for reflecting light energy impinging thereupon whereby a reflective tag reflects predetermined wavelengths along with predetermined information embedded in said tag.

17. A multiple layer reflective tag comprising:
a first layer made of a transparent material for the transmission of light therethrough;
a printed second layer applied to either the top or bottom surface of said first layer, said printed second layer having a plurality of apertures therein;
a third layer positioned under said first and second layer and made of a wavelength control material for passing predetermined wavelength of light therethrough and reflecting or absorbing other wavelengths of light therefrom; and
a reflective layer positioned under said third layer and having a reflective surface for reflecting light energy impinging thereupon whereby a reflective tag reflects predetermined wavelengths along with predetermined information embedded in said tag.

18. The multiple layer reflective tag in accordance with claim 17 having a fourth layer positioned between said third layer and said reflective layer, said fourth layer being a layer of wavelength control material for reflecting or absorbing predetermined wavelengths of light energy.
